(19) United States
(12) Patent Application Publication
(10) Pub. No.: US 2011/0197690 A1
(43) Pub. Date: Aug. 18, 2011

(54) LINEAR DRIVE FOR A PIVOTALLY SUPPORTED PANEL OR A PIVOTALY SUPPORTED HARD OR SOFT TOP OF A VEHICLE

(76) Inventor: Gerhard Kolbl, Garching bei Munchen (DE)

(21) Appl. No.: 12/866,363

(22) PCT Filed: Feb. 3, 2009
(86) PCT No.: PCT/EP2009/000703

§ 371 Date: Nov. 15, 2010

(30) Foreign Application Priority Data
Feb. 5, 2008 (DE) 10 2008 007 536.1

(51) Int. Cl. F16H 25/08

(52) U.S. Cl. 74/25

(57) ABSTRACT

The invention is based on the object of driving a trunk lid or hard or soft tops of a vehicle by a motor as efficiently and as economically as possible. Typically a hydraulic cylinder having very high energy density, or an electromechanical spindle drive, generally provided with a planetary gear as is known from DE 10 2004 040 170 A 1, is used today. Said arrangement has the disadvantage that the transmission comprises several wheels in order to enable an accordingly high gear ratio for the required slow rotational movement of the spindle. In the process, a loud operating noise is produced. The invention relates to a linear drive having a high-ratio single-step manual transmission and the possibility of integrating an energy storage, for example a helical spring or a gas pressure spring, and the possibility of integrating a hydraulic brake. The invention is particularly suitable for driving a cover or panels/doors/tops/moveable hardtops or other moveable components on vehicles, on other mobile systems or on stationary devices. It is supported on the vehicle body or the stationary device and on the cover or the moveable element, which in turn is rotatably connected to a hinge on the vehicle body or the stationary device.

### TECHNICAL FIELD

The invention is directed generally toward operation of a trunk lid of a vehicle as efficiently and economically as possible with a motor.

### BACKGROUND

Today, a hydraulic cylinder with very high energy density or an electromechanical spindle drive, usually equipped with a planetary gear mechanism, is common for this purpose.

Quite specific requirements are imposed on drives in this area of use:

1. The drive must be implemented in a small design space, both in terms of diameter and length.
2. It must be able to transfer large forces linearly (comparable to a hydraulic cylinder).
3. The drive must be very smooth.
4. Linear movement must also be possible manually without a large force.
5. The potential energy of the trunk lid must be temporarily storable in the drive.
6. If the drive has stopped in any location, the trunk lid must remain in this position.
7. Installation into and removal from the vehicle must be accomplished with limited expense.
8. Temperature fluctuations should have no effect, if possible, on the behavior of the drive.

Depending on the OEM, additional requirements are imposed on the drive. All requirements cannot be met by any of the drive systems now mass produced.

### BRIEF SUMMARY

All the requirements just described can be fulfilled on such a linear drive with the drive system presented in the following figures.

The electric motor supplies the power required for movement of the trunk lid. The electric motor must be a hollow shaft motor and can be a DC motor or an electronically commutated motor (EC). An EC motor is to be preferred, since they are more durable, permit a more favorable torque trend and have lower noise development, owing to the absence of a commutator.

The gear mechanism converts the torque introduced by the electric motor in a single gear step to the required linear movement. The rolling movement of the internal ring and the relatively slow speed cause limited friction and limited noise, which guarantees high efficiency in the one-step gear mechanism.

The transferrable linear force can be varied by successive switching of gear stages.

The gear mechanism also permits individual connection or disconnection of the rotating gear mechanism from the linear movement.

The coil spring serves to temporarily store the potential energy of the trunk lid by spring tension.

A gas pressure spring that temporarily stores the potential energy as pressure can also act in the interior of the spindle instead of a coil spring.

With proper layout of the spring, the trunk lid can be held almost in equilibrium in each position. Only the difference force between the trunk lid and spring and acceleration forces need be applied by the electric motor to move the trunk lid.

If the gear mechanism is decoupled, the linear drive is held at the corresponding position with the preset force of the hydraulic brake. If this is overcome, the linear drive can be freely moved manually.

In the described design, the drive requires only one electrical connection and can be installed and replaced via the connection points, like a usual gas pressure spring.

During use of a coil spring, the linear drive is almost insensitive to temperature effects and supplies roughly the same power over a broad temperature range.

Advantage of the linear drive:

The advantage of the linear drive, on the one hand, lies in the fact that the gear mechanism itself is switchable and therefore separable from the spindle. An additional system is not required for this purpose. The spindle is fully released. The desired manual operation can be freely configured.

The axial force can also be varied by the number of gear stages.

Arrangement of the drive ring bearing around the finely threaded spindle permits a very compact gear mechanism and therefore a high one-stage transmission with a large force transfer in a very limited design space.

Because of the high efficiency of the gear mechanism, the electric motor can be designed relatively small and therefore a small design space implemented.

Because of low friction in the gear mechanism, the spindle requires no rotation protection relative to the housing.

By arranging the gear mechanism and electric motor outside around the spindle, additional functions, like the holding function of a hydraulic brake or a gas pressure spring, can be integrated in its internal area.

The speed for the electric motor stipulated by the gear mechanism falls within a pleasant sound range. Only low noise is produced in the gear mechanism, because of the design.

The force being transferred axially is dependent on the number of employed drive ring bearings (1.2), which engage directly on the fine thread. In contrast to a hydraulic cylinder, whose piston size is dependent on the piston rod, which always must be enclosed by the hydraulic cylinder, the fine-thread spindle (1.1) can have the same diameter over its entire length, which is not limited by required components. This leads to a design space advantage with higher force density of the linear drive. The drive unit (4.14 and 4.15) with the large outside diameter therefore need not go beyond half-cylinder length, but is defined by the required axial force. The length of the cylinder can extend up to the buckling length.

Overall, the linear drive can be laid out as a highly integrated system in the smallest possible design space and combines the advantages of hydraulic and electromechanical linear drives now commonly used.

### BRIEF DESCRIPTION OF THE DRAWINGS

FIG. 1 is a sketch of the primary gear functional elements.

FIG. 2 is a sectional view along axis A-A of FIG. 1.

FIG. 3 is a sectional view along axis B-B of FIG. 2.

FIG. 4 shows a drive with a hydraulic brake position engaged.

FIG. 5 shows a drive with a hydraulic brake position disengaged.

FIG. 6 shows a drive without a hydraulic brake, with a gas spring position engaged.

FIG. 7 shows a drive without a hydraulic brake, with a gas spring position disengaged.

FIG. 8 shows a drive without a hydraulic brake, with gas spring space optimized.

FIG. 9 shows a linear drive applied to a truck lid of a vehicle.

FIG. 10 shows a drive with a hydraulic brake and coil spring in a disengaged position.

FIG. 11 shows an example of a hydraulic brake valve.

### DETAILED DESCRIPTION

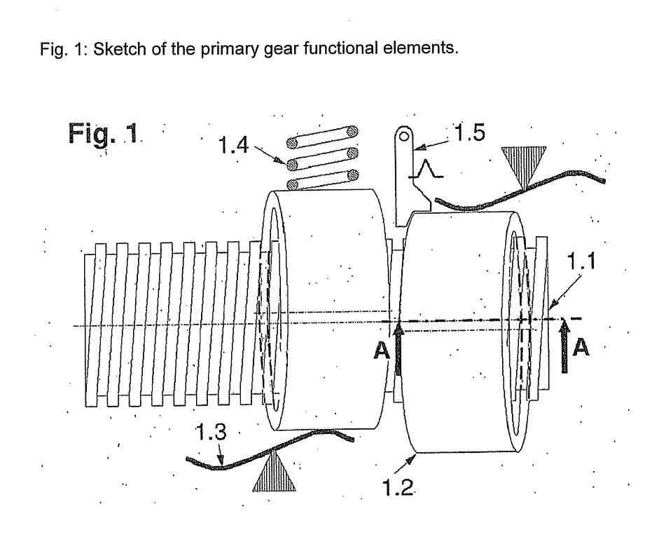

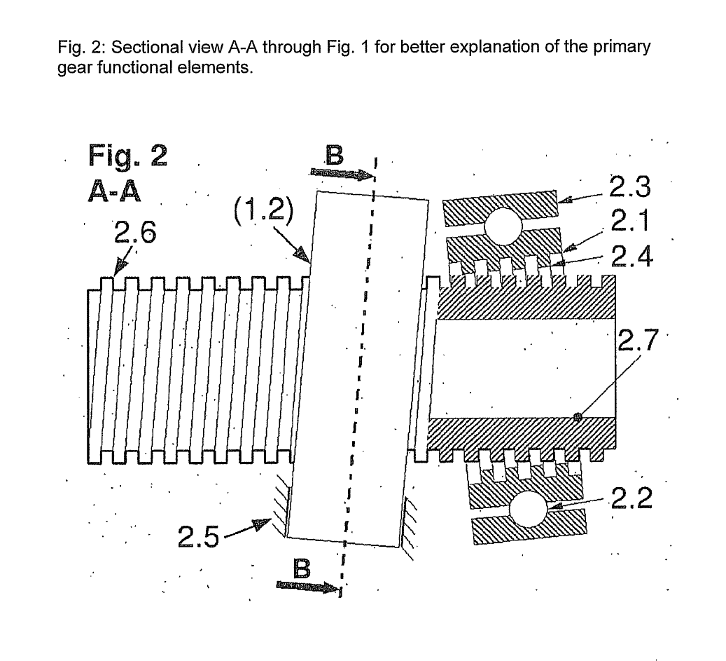

Conversion of the rotary movement of an electric motor to the desired linear movement occurs via the gear mechanism described below according to FIG. 1. The gear mechanism is a one-stage switchable gear mechanism with fixed transmission.

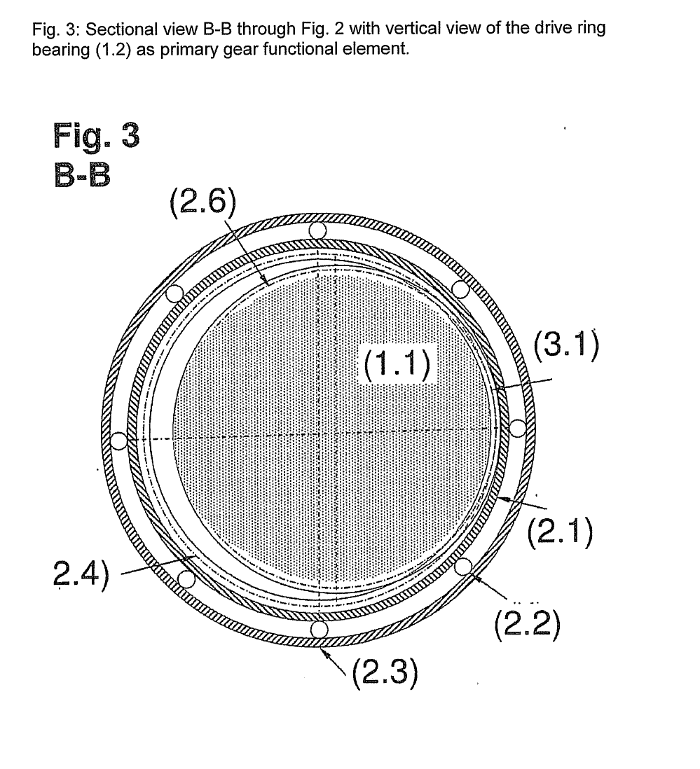

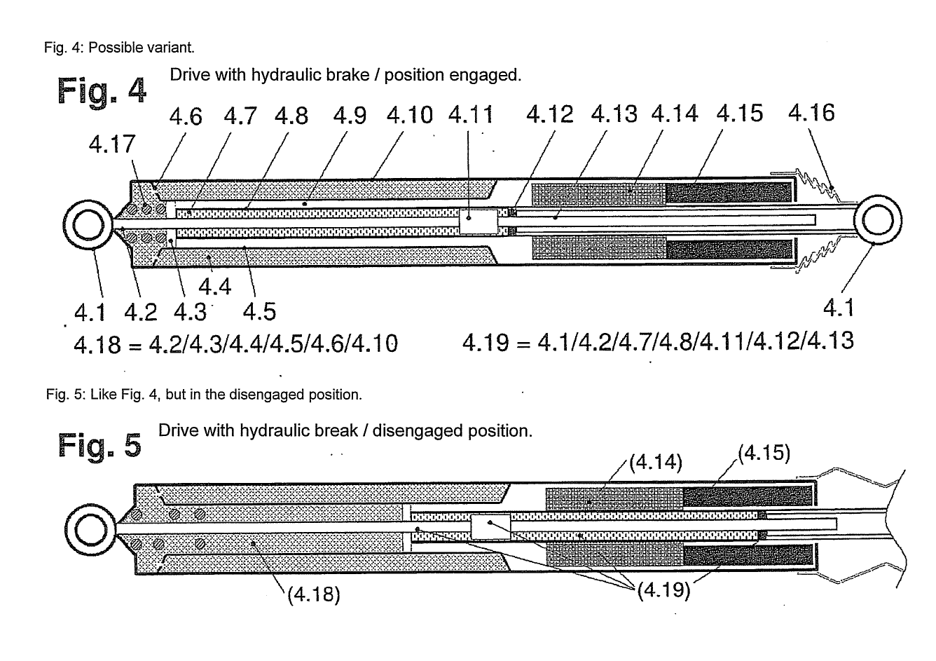

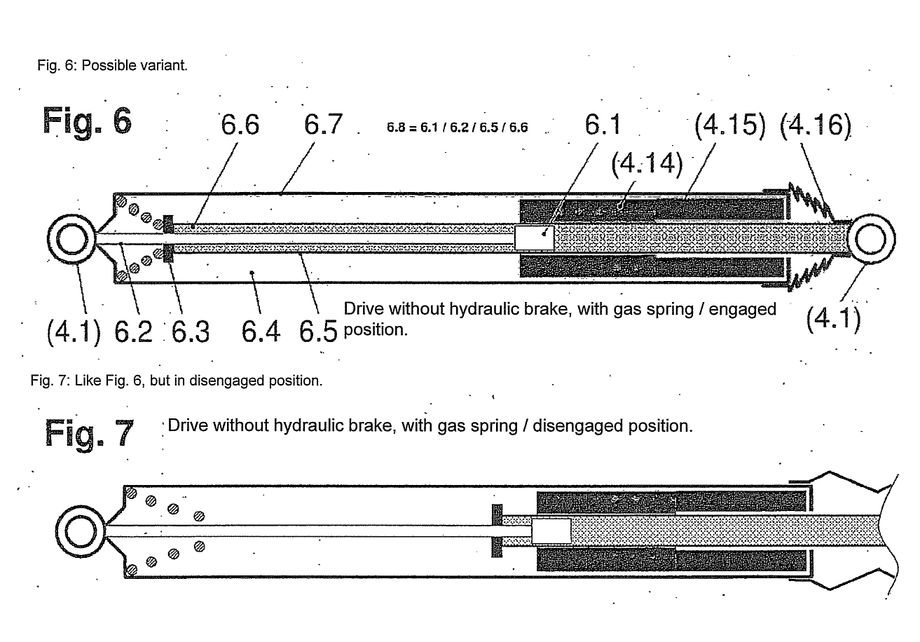

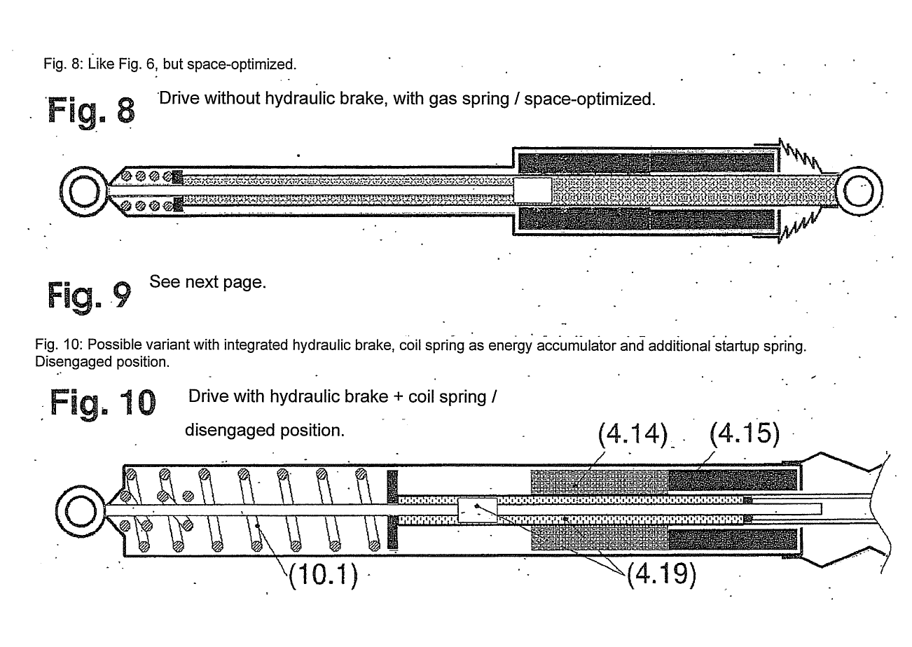

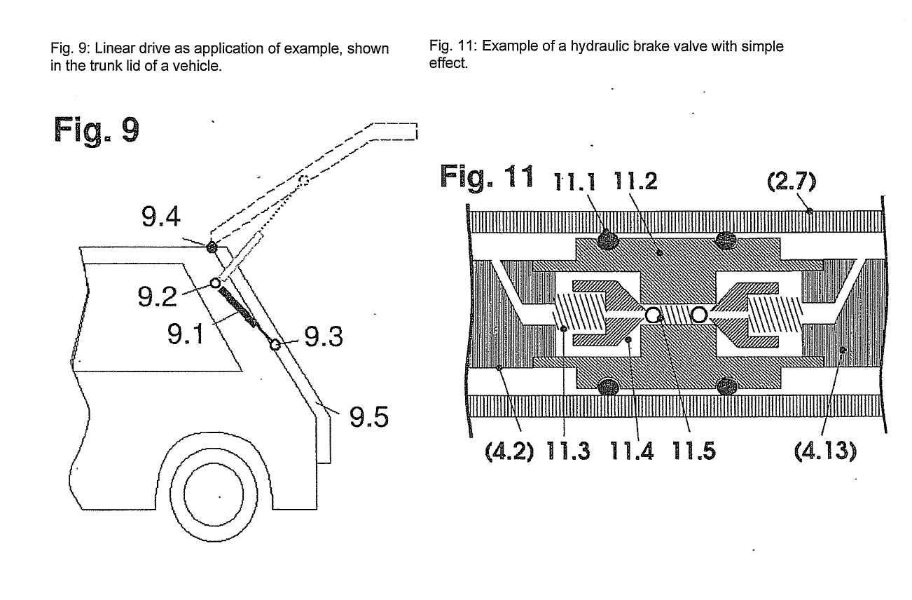

Switching of the gear mechanism occurs by operating the snap-in device (1.3), shown here, for example, by a lever device. During operation of the snap-in device (1.3), the drive ring bearing (1.2) is brought into an eccentric position relative to the fine-thread spindle (1.1). The radial grooves (2.4) of the drive ring (2.1), readily visible in the section of FIG. 2, then snap into the thread of the fine-thread spindle (1.1) and produce shape-mating with the crescent-shaped thread contact ratio (3.1) shown in FIG. 3. The drive ring bearing (1.2) must be aligned obliquely to the fine-thread spindle (1.1) according to the thread pitch at the same angle.

The drive mechanism, as an alternative in a base version, can also be a non-switchable gear mechanism. In an emergency, the element being moved remains in this stopped position.

The drive ring bearing (1.2) is fixed in the effect direction by the axial bearing (2.5). If the thrust bearing (2.5) is driven to rotate, the axially fixed drive ring-bearing outer ring (2.3) is carried along and rolls along the ball bearings (2.2) in drive ring (2.1). The drive ring (2.1) engages the thread of the fine-thread spindle (1.1) via the radial grooves (2.4). The drive ring (2.1) is forced into the fine-thread spindle (1.1) by rolling of the ball bearings (2.2) and is screwed along the spindle in this way. Rotation of a linear offset of the drive ring bearing (1.2) relative to the fine-thread spindle (1.1) is established in this way at the height of the thread pitch. The transmission ratio is therefore established with the thread pitch. The axial force is transferred via the crescent-shaped thread contact ratio (3.1). The gear mechanism, as an alternative, can always be biased in the engagement position. With a disengagement device (1.3), decoupling is achieved, in which the drive ring bearing is brought into the center position relative to the fine-thread spindle against a spring force by means of a lever.

The disengagement device can be operated manually or via a control element. The control element is activated, if an electronic mechanism recognizes the need for the snapping-in or snapping-out of the drive ring bearings. The control element, for example, can be an electrically driven lever or lifter, driven by a motor or lifting magnet.

By the use of fine thread, the entire force transfer occurs via the thread flanks (2.6) and radial grooves (2.4) in the outer area of the fine-thread spindle (1.1). The required axial force can be applied via a wall thickness to be defined. If transfer of the axial force occurs over the wall thickness so established, the material core of the fine-thread spindle (1.1) is then not required. It can therefore be designed as a fine-thread tube (2.7), and the inner area used for additional functions, for example, as a gas pressure spring (6.8) or as a hydraulic brake (4.19).

During unloading of the engagement device (1.3), the drive ring bearing (1.2) is realigned into the center position relative to the fine-thread spindle (1.1) by the disengagement device (1.4), shown here by a spring. Engagement of the radial grooves (2.4) in the fine-thread spindle (1.1) is released and the fine-thread spindle (1.1) is therefore axially movable without shape-mating or resistance and the decoupled lid or cover is therefore movable by hand.

The axial force is transferred via the crescent-shaped thread contact ratio (3.1) between fine-thread spindle (1.1) and radial grooves (2.4). The height of the axially transferrable force can be designed variably adjustable by the number of drive ring bearings (1.2).

A desired weight balance can be created, for example, required for a vehicle trunk lid, via gas pressure springs (4.18) and (6.8), integrated either outside on the cylinder tube (6.7) or inside in the fine-thread spindle (2.7). If the disengagement device (1.4) is activated in the linear drive, the trunk lid can be held roughly in equilibrium, despite the freely switched gear mechanism (FIG. 1).

The differing force is applied via the hydraulic brake (4.19) and the trunk lid is kept in its position with the predefined braking force. After surpassing the set braking force, the drive can be moved by hand in stepless fashion, free of disturbance. A sketch of a one-stage hydraulic brake is shown in FIG. 11, which can naturally also be designed two-stage, depending on the requirement.

The invention is shown in the following drawings and described in detail with reference to the drawings. Individual elements of the depictions are continuously numbered and assigned to the drawings by means of the first number before the decimal point.

1. Linear drive for a pivotable lid or pivotable hard or soft top of a vehicle, comprising
an electric drive motor,
a threaded spindle and
a switchable gear mechanism,
wherein the drive motor is a hollow shaft motor arranged coaxial to the threaded spindle and the switchable gear mechanism is arranged around the threaded spindle.

2. Linear drive according to claim 1, wherein the hollow shaft motor is arranged around the threaded spindle.

3. Linear drive according to claim 1, wherein the gear mechanism is upshifted in one stage and has drive ring bearings that are ball-mounted and engage in the threaded spindle via radial grooves.

4. Linear drive according to claim 1, wherein the gear mechanism can be actively separated from the threaded spindle by a disengagement device.

5. Linear drive according to claim 1, wherein the gear mechanism can be separated passively by a disengagement device from the threaded spindle.

6. Linear drive according to claim 3, wherein the drive ring bearing can be fixed in an engaged position by a drive ring bearing fixation device.

7. Linear drive according to claim 1, wherein the threaded spindle is a fine-thread spindle tube.

8. Linear drive according to claim 1, wherein a gas pressure spring is integrated as an energy accumulator within a cylinder outer sleeve.

9. Linear drive according to claim 1, wherein a coil spring is integrated as an energy accumulator within a cylinder outer sleeve.

10. Linear drive according to claim 1, wherein the electric motor transfers rotational movement directly to the threaded spindle and converts this rotary movement to an axial movement via the gear mechanism fixed axially in the housing, in which drive ring-bearing outer rings are mounted directly in the housing.

11. Linear drive according to claim 1, wherein axially transferrable force can be varied via the number of drive ring bearings in the gear mechanism.

12. Linear drive according to claim 7, wherein a hydraulic brake is integrated in the fine-thread spindle tube, so that on surpassing the pressure preset in the hydraulic brake, the fine-thread spindle tube is axially released and can be moved in stepless fashion and on falling short of the preset pressure is held at an axial position again.

13. Linear drive according to claim 7, wherein the fine-thread spindle tube is designed as a gas pressure spring and is integrated in the linear drive as a space-saving energy accumulator.

14. Linear drive according to claim 8, wherein a gas pressure spring or a coil spring is supported by a startup spring during startup from unfavorable kinematic positions.
